(19) United States
(12) Patent Application Publication
(10) Pub. No.: US 2004/0046067 A1
(43) Pub. Date: Mar. 11, 2004

(54) Showerhead

(75) Inventor: Hing Fai Tse, Kowloon Bay (HK)

Correspondence Address: LEYDIG VOIT & MAYER, LTD, 700 THIRTEENTH ST. NW, SUITE 300, WASHINGTON, DC, 20005-3960, US

(73) Assignee: Brand New Technology Ltd., Kowloon Bay (HK)

(21) Appl. No.: 10/232,696

(22) Filed: Sep. 3, 2002

(51) Int. Cl. B05B 15/08

(52) U.S. Cl. 239/587.4

(57) ABSTRACT

A showerhead comprising a body having an inlet, an outlet and an internal passage for delivering water from the inlet to the outlet. The outlet comprises a plurality of apertures for discharging water. The showerhead includes a stem supporting the body for use and for delivering water from a water supply to the inlet. A valve is provided internally of the showerhead for temporarily interrupting the flow of water. The valve comprises co-operating first and second valve members movable relatively to each other for operation and includes manual operating means for causing relative movement between the valve members. The operating means is associated with an external surface of the showerhead, and may be provided by the showerhead body proper.

The present invention relates to a showerhead.

### BACKGROUND OF THE INVENTION

The turning on and off of water discharged by existing showerheads is invariably controlled by means of the mains water taps to which the showerheads are connected. During normal use, showerheads are often turned off temporarily and repeatedly to save water, for example when soap or shampoo is being applied. For this purpose, the use of the mains water taps may be inconvenient, in that the previously chosen flow rate and/or temperature of the water will often be disturbed when the showerheads are turned on again.

The invention seeks to mitigate or at least alleviate such a problem by providing an improved showerhead.

### SUMMARY OF THE INVENTION

According to the invention, there is provided a showerhead comprising a body having an inlet, an outlet and an internal passage for delivering water from the inlet to the outlet. The outlet comprises a plurality of apertures for discharging water. The showerhead includes a support member supporting the body for use and for delivering water from a water supply to the inlet. A valve is provided internally of the showerhead for temporarily interrupting the flow of water. The valve comprises co-operating first and second valve members movable relatively to each other for operation and includes manual operating means for causing relative movement between the valve members. The operating means is associated with an external surface of the showerhead.

Preferably, the body is movably connected to the support member, and the operating means is provided by the body proper.

More preferably, the body is slidable relative to the support member for operating the valve.

It is preferred that the first valve member is fixed within the body, and the second valve member is connected to the support member.

The valve is preferably provided wholly within the body.

In a preferred embodiment, the first and second valve members are tubular and are interengaged for relative telescopic movement.

More preferably, the tubular valve members have respective lateral openings for alignment to open the valve and mis-alignment to close the valve.

Advantageously, the valve is constructed to have a slightly leaking closed condition that permits a limited flow of water.

In a specific embodiment, the support member comprises a hollow stem for connection to a fixed water supply pipe, and the body is connected at its inlet to the stem by means of a ball joint.

More specifically, the body includes a ball socket slidably supported at its inlet, and the ball socket is fixedly connected to the second valve member.

### BRIEF DESCRIPTION OF DRAWINGS

The invention will now be more particularly described, by way of example only, with reference to the accompanying drawing, in which:

FIG. 1 is a front perspective view of an embodiment of a showerhead in accordance with the invention;

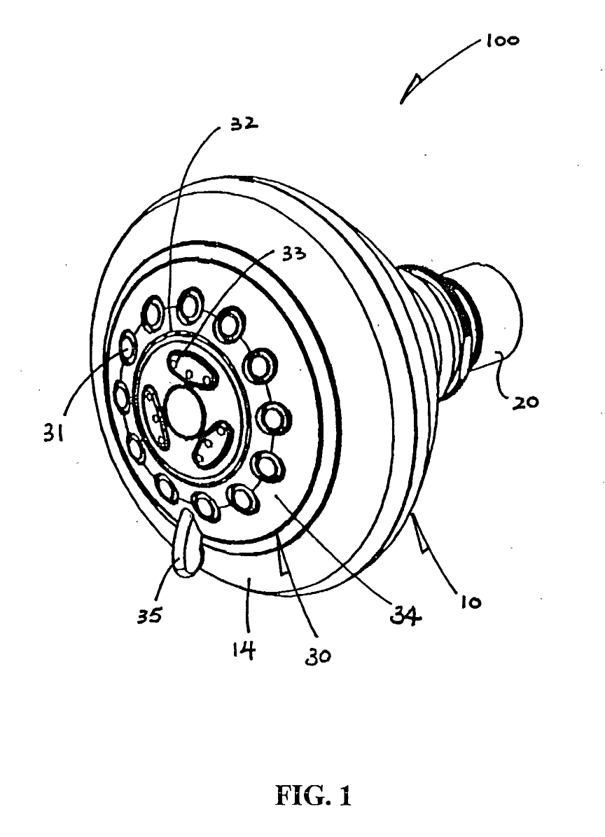

FIG. 2 is a right side view of the showerhead of FIG. 1;

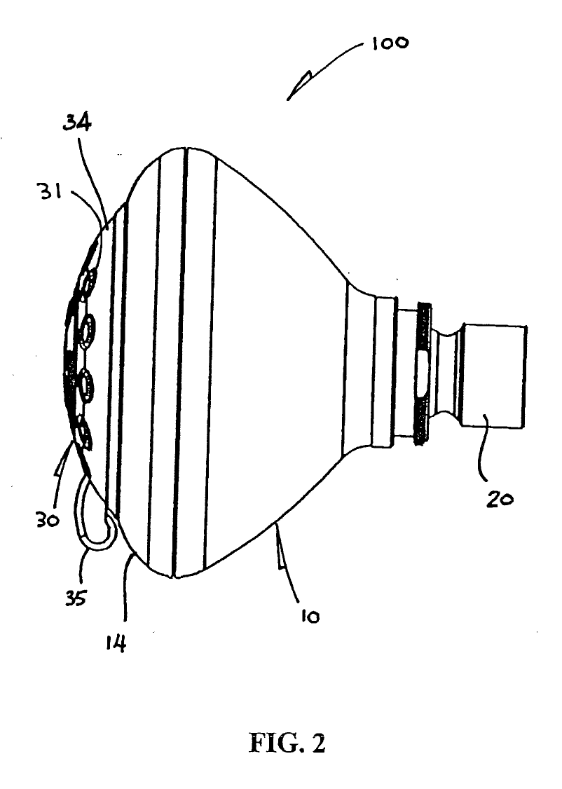

FIG. 3 is a cross-sectional top plan view of the showerhead of FIG. 1, showing the showerhead in an ON condition; and

FIG. 4 is a cross-sectional top plan view corresponding to FIG. 3, showing the showerhead in a PAUSE condition.

### DETAILED DESCRIPTION OF PREFERRED EMBODIMENT

Referring to the drawings, there is shown a showerhead 100 embodying the invention, which showerhead 100 belongs to the wall-mounted type and has a generally conical body 10 and a hollow stem 20 projecting from a rear apex end of the body 10. The stem 20 has an internally screw-threaded rear end 22 for connection to a water supply pipe fixed on the wall of a bathroom, and includes a generally spherical front end 24. The stem 20 serves to support the body 10 for use and to deliver water supplied from the water pipe to the interior of the body 10.

The showerhead body 10 has a central rear inlet opening 12, within which a tubular ball socket 26 is co-axially located for limited relative sliding movement. The ball socket 26 receives the spherical front end 24 of the stem 20 as a ball joint such that the body 10 is swivellable within an acute conical angle, and 360° rotatable, about the stem 20 to point in a desired direction. As the ball socket 26 is slidably connected to the inlet 12, the body 10 is also slidable relative to the stem 20 in opposite directions along the central axis of the body 10.

The showerhead body 10 has a convex annular front surface 14 including a relatively large circular central opening 16 that locates a water discharge assembly 30. The discharge assembly 30 has a circular body 34 including a convex front surface that is formed with three concentric rings of apertures 31 to 33 acting as an outlet for discharging water in different manners. The outer ring apertures 31 are considerably larger than the inner ring apertures 33, both being circular, and the middle ring apertures 32 are generally flat.

The discharge assembly 30 includes three manifold passages (generally known and thus not clearly shown in the drawings for clarity) within its body 34, whose exit ends terminate at the corresponding rings of apertures 31 to 33 for diverting water thereto for discharge. The manifold passages include respective sections of various designs and at least one of them runs through a movable device, for discharging water in different manners, including pulsation, and at different forces.

The assembly body 34 is manually rotatable relative to the showerhead body 10 into different angular positions for selectively connecting the entrance ends of the manifold passages to a water distribution point 40. To facilitate rotation, the body 34 includes an external tab 35.

The showerhead 100 includes a built-in valve 50 housed wholly within the body 10. The valve 50 is provided between the stem 20 and the distribution point 40 for controlling the flow of water from the former to the latter, to offer additional control apart from the mains water tap to which the showerhead 100 is connected.

The valve 50 is formed by a pair of co-operating first and second tubular valve members 51 and 52 movable relatively to each other for operation. The first valve member 51 is mounted co-axially on a fixed collar 59 in the showerhead body 10, and the second valve member 52 is jointed coaxially with the ball socket 26. The first valve member 51 engages co-axially around the second valve member 52 for relative telescopic movement upon manual sliding movement of the body 10 relative to the stem 20.

The second valve member 52 has a side hole 54 through the wall at its inner end surrounded by the first valve member 51. The outer end wall of the first valve member 51 surrounds the collar 59 for mounting thereby, and is radially expanded to form an inner shoulder 55 aligned axially with the collar 59 and a void 56 immediately outside the collar 59. One end of the void 56 acts as the aforesaid distribution point 40. A hole 53 is formed between the shoulder 55 of the first valve member 51 and the collar 59. The first (valve member) hole 53 directly communicates with the void 56, and is positioned right next to the second (valve member) hole 54.

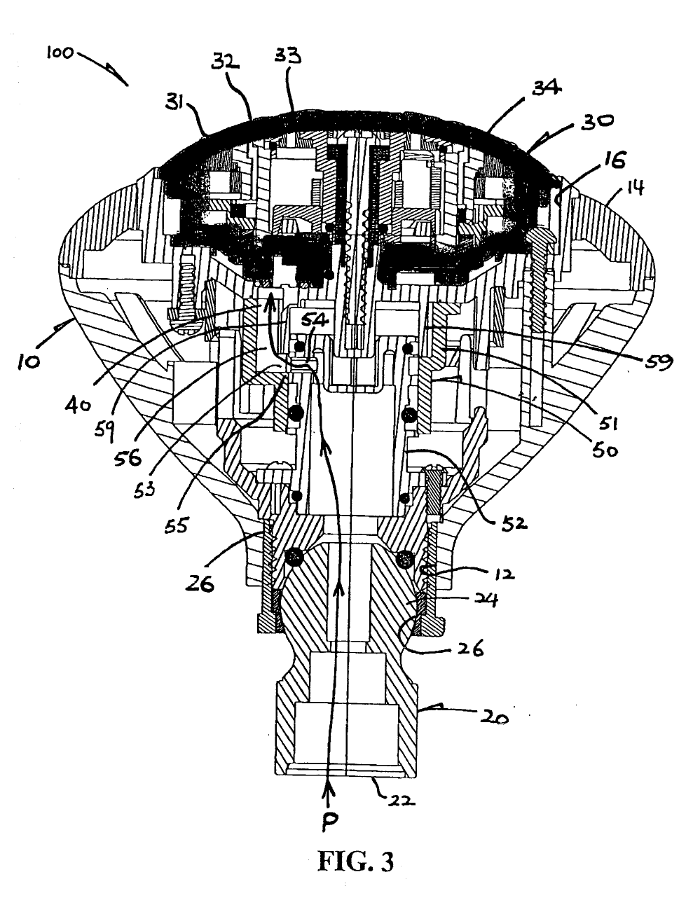

While the showerhead body 10 is at an outer position relative to the stem 20, the first valve member 51 is positioned relative to the second valve member 52 such that the first hole 53 is aligned with the second hole 54, whereby the valve 50 is opened (FIG. 3). Opening of the valve 50 permits normal use of the showerhead 100 to discharge water (along path P) at a chosen flow rate and/or temperature.

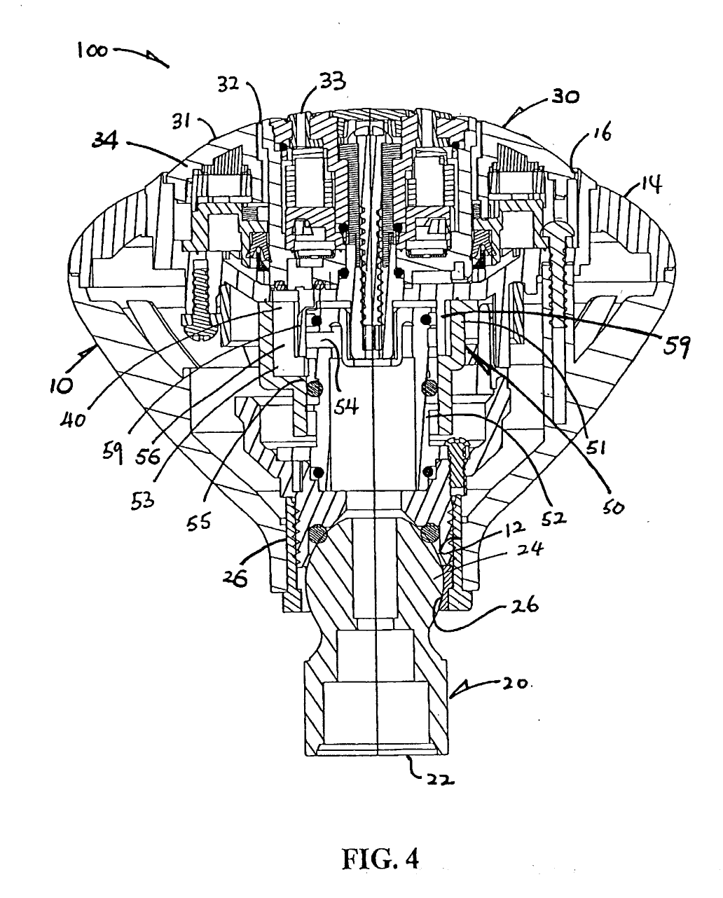

The showerhead 100 may be switched into a PAUSE condition for temporarily interrupting the water flow by pushing the body 10 towards the stem 20. In doing so, the first valve member 51 is slid outwardly from the second valve member 52 such that the first hole 53 moves aside and becomes out of alignment (misaligned) with the second hole 54, whereby the valve 50 is closed (FIG. 4). Closing of the valve 50 practically stops the flow of water.

The valve 50 is constructed to be slightly leaking such that, while in the closed condition, it will not shut off the water flow completely. More specifically, the valve 50 will reduce the flow rate to a minimum such that water will seep out in drops for example. This can be achieved by leaving a small gap or forming a small groove in the interface between the two valve members 51 and 52. Such a minimum flow rate, say 7.01/hr, may be required by the local safety regulation that prohibits the use of a showerhead device to completely shut off water from a mains water supply as the device is normally not made sufficiently strong to withstand the mains supply pressure.

The showerhead 100 may subsequently be switched back to the normal use condition by pulling the body 10 outwardly from the stem 20 thereby opening the valve 50 through realignment of the two holes 53 and 54. As the mains water tap has not been manipulated, the previously chosen flow rate and/or temperature of the water will not be disturbed and can therefore be resumed.

It is clear that the showerhead body 10 proper is used as manual operating means, by gripping its external surface, for turning on and off the internal valve 50. A separate operating member may of course be used instead, such as a press knob provided on the external surface on one side of the body 10 for depression to actuate either valve member 51/52.

It is envisaged that the subject invention may also be applied to a showerhead of the handgrip type, in which case the showerhead body may be movable by hand relative to the handle for operating the valve, or a manual switch on the handle may be employed.

The invention has been given by way of example only, and various other modifications of and/or alterations to the described embodiment may be made by persons skilled in the art without departing from the scope of the invention as specified in the appended claims.

What is claimed is:

1. A showerhead comprising a body having an inlet, an outlet and an internal passage for delivering water from the inlet to the outlet, said outlet comprising a plurality of apertures for discharging water, a support member supporting the body for use and for delivering water from a water supply to the inlet, and a valve provided internally of the showerhead for temporarily interrupting the flow of water, said valve comprising co-operating first and second valve members movable relatively to each other for operation and including manual operating means for causing relative movement between the valve members, said operating means being associated with an external surface of the showerhead.

2. The showerhead as claimed in claim 1, wherein the body is movably connected to the support member, and the operating means is provided by the body proper.

3. The showerhead as claimed in claim 2, wherein the body is slidable relative to the support member for operating the valve.

4. The showerhead as claimed in claim 2 or claim 3, wherein the first valve member is fixed within the body, and the second valve member is connected to the support member.

5. The showerhead as claimed in any one of claims 1 to 4, wherein the valve is provided wholly within the body.

6. The showerhead as claimed in any one of claims 1 to 5, wherein the first and second valve members are tubular and are interengaged for relative telescopic movement.

7. The showerhead as claimed in claim 6, wherein the tubular valve members have respective lateral openings for alignment to open the valve and misalignment to close the valve.

8. The showerhead as claimed in any one of claims 1 to 7, wherein the valve is constructed to have a slightly leaking closed condition that permits a limited flow of water.

9. The showerhead as claimed in any one of claims 1 to 8, wherein the support member comprises a hollow stem for connection to a fixed water supply pipe, and the body is connected at its inlet to the stem by means of a ball joint.

10. The showerhead as claimed in claim 9, wherein the body includes a ball socket slidably supported at its inlet, and the ball socket is fixedly connected to the second valve member.
